(19) United States
(12) Patent Application Publication
(10) Pub. No.: US 2012/0016761 A1
(43) Pub. Date: Jan. 19, 2012

(54) Techniques For Provisioning Content

(75) Inventors: Tarek Najm, Kirkland, WA (US); Ian Ferriera, Issaquah, WA (US)

(73) Assignee: Enyama, Inc., Kirkland, WA (US)

(21) Appl. No.: 13/184,421

(22) Filed: Jul. 15, 2011

Related U.S. Application Data
(60) Provisional application No. 61/364,726, filed on Jul. 15, 2010.

(51) Int. Cl. G06Q 30/00

(52) U.S. Cl. 705/26.1

(57) ABSTRACT

Techniques including systems and methods for facilitating transactions in connection with electronic trading cards. A finite number of electronic cards are created and associated with owners. Electronic cards are allowed to be bought, sold, traded, gifted, and/or otherwise involved in transactions. Card-related transactions may be conducted in connection with a social network. In one embodiment, publishers provide content for electronic trading cards and determine the timing and manner in which the cards are distributed.

### CROSS REFERENCE TO RELATED APPLICATIONS

This application claims the benefit of expired U.S. provisional application No. 61/364,726, entitled “Techniques for Provisioning Content” (Attorney Docket No. 92928-788776), filed on Jul. 15, 2010, the full disclosure of which, including appendices, is incorporated herein by reference.

### BACKGROUND OF THE INVENTION

Trading cards and other collectible items enjoy a wide following. Not only are trading cards enjoyed for their content, but for characteristics that encourage buying, selling, trading, and collecting of the cards. The values of cards, for instance, vary for various reasons including the frame of a card's subject, a card's rarity, a card's condition, and other factors. Accordingly, collectors of cards will often give up something of value in order to obtain other cards. A collector, for example, may use money to buy cards from a seller, trade one or more cards for one or more other cards, or otherwise engage in card-related transactions.

Trading cards are typically printed by a printing press and distributed to various people. Consumers, for instance, may purchase packages of multiple cards, not knowing what the package contains until opened. Some of the cards in a package may be retained while others may be sold, traded, or gifted. As another example, consumers who desire a particular card may enter a store (either physical or electronic) that sells cards and purchase individual cards. Transfer of a card from one person to another generally requires physical transfer of the card, either in person, by mail, courier, or other methods.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

Techniques described and suggested herein include systems and methods related to an integrated platform that enables the emergence of an ecosystem of participants in an open, social and dynamic marketplace. In an embodiment, a collection comprising a number of electronic trading cards are created and can be distributed to users. A card publisher(s) is typically able to digitally control one or more of various aspects of the cards, including without limitation design and/or supply of individual or groups of cards, as well as card packaging, rarity, aspects of release to users (e.g., timing, volume, pricing, discount options, etc.). Users with electronic trading cards may be able to buy, sell, trade, gift, receive, sign and otherwise involve electronic trading cards in transactions and other activities. Accordingly, users may be able to acquire electronic trading cards for various purposes, such as collection, investment, competitions, and generally any activity involving electronic trading cards.

The above summary provides an overview of several features of the invention, in accordance with various embodiments. For a fuller understanding of the nature and advantages of the present invention, reference should be made to the ensuing detailed description and accompanying drawings.

### BRIEF DESCRIPTION OF THE DRAWINGS

FIG. 1 is a simplified block diagram of a computer system that may be used to practice an embodiment of the present invention.

FIG. 2 is a diagram of an illustrative example of a database table that can be used to store information about electronic cards, in accordance with an embodiment.

FIG. 3 is a flowchart for an illustrative example of a process for transferring ownership of cards from one owner to another, in accordance with an embodiment.

FIG. 4 is a flowchart for an illustrative example of a process for completing a transaction that may involve one or more points and/or cards, in accordance with an embodiment.

FIG. 5 is a flowchart for an illustrative example of a process for facilitating an offer and/or counteroffer, in accordance with an embodiment.

FIG. 6 is a flowchart for an illustrative example of a process for facilitating a transaction, possibly using mobile devices, in accordance with an embodiment.

FIG. 7 is a flowchart for an illustrative example of a process for identifying cards that have errors in associated content, in accordance with an embodiment.

FIG. 8 is a flowchart for an illustrative example of a process for modifying the condition of a card, in accordance with an embodiment.

FIG. 9 is a flowchart for an illustrative example of a process for facilitating signatures of cards, in accordance with an embodiment.

FIG. 10 is a diagram of an example environment that may be used to implement various embodiments of the invention.

FIG. 11 is an illustrative example of an interface page that a publisher may utilize during a process for publishing a collection of cards, in accordance with an embodiment.

FIG. 12 is an illustrative example of an interface page to which the publisher may navigate after visiting the page shown in FIG. 11.

FIG. 13 is an illustrative example of an interface page to which the publisher may navigate after visiting the page shown in FIG. 12.

FIG. 14 is an illustrative example of an interface page to which the publisher may navigate after visiting the page shown in FIG. 13.

### DETAILED DESCRIPTION OF THE INVENTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

The present invention provides an integrated platform that enables the emergence of an ecosystem of participants in an open, social and dynamic marketplace, as well as related systems and methods. In an embodiment, electronic trading cards and/or collections thereof are created and can be distributed to users, while enabling a card publisher or other entity to maintain control over one or more aspects of the cards, in some cases, even subsequent to release or distribution to a user. Thus, the present invention enables an entity such as a card publisher (or multiple card publishers) to digitally control one or more of various aspects of the cards, such as design and/or supply of individual or groups of cards, as well as card packaging, rarity, aspects of release to users (e.g., timing, volume, pricing, discount options, etc.). Users with electronic trading cards may be able to buy, sell, trade, gift, receive, sign and otherwise involve electronic trading cards in transactions and other activities. Accordingly, users may be able to acquire electronic trading cards for various purposes, such as collection, investment, competitions, and generally any activity involving electronic trading cards.

In one embodiment, a set of electronic trading cards can be associated with a collection or a series. The collection may be associated with a theme, such as a sport, a television series, a movie, a game, or with a particular event, as well as individuals (e.g., sports figures, celebrities, etc.), and/or combinations thereof. As an example, a collection of electronic trading cards may be associated with a professional baseball league and cards of the collection may be associated with players of the league for a particular season. As another example, a collection of electronic trading cards may be associated with a movie or television show and cards of the collection may be associated with characters of the show. In this manner, fans of a sport, a show, or other theme else may buy, sell, trade, and otherwise engage in activities with related electronic trading cards.

In one embodiment, users may participate in a social network and may participate in electronic trading card-related activities as part of their participation in the social network. A social network may include a set of user profiles that are linked to one another through associations maintained in a data store. The profiles may be nodes in a graph that has edges representing associations between the profiles. For example, one profile may be linked to another profile because corresponding users have indicated they are friends or acquaintances of one another. Thus, the two profiles are directly linked in the graph-theoretical sense. Associations (links in a graph) may be indirect as well. For an example of how users may interact with a social network, users may see what electronic trading cards are owned by people indicated as friends by the social network (e.g. users whose profiles are directly linked to one another). Users may also become friends with other members of the social network who share common interests, as determined by card ownership. For example, a user who enjoys playing an electronic trading card-related game may search for other users who enjoy playing the game and request that those users link their social network accounts with his or her account. Users can also see which of their friends have acquired the most electronic trading cards, who have acquired the most valuable electronic trading cards, and the like.

Entities of various types may be able to publish their own electronic trading cards, in accordance with various embodiments of the present disclosure. Publishers may design cards, determine how many cards will be published, determine how cards will be packaged, determine how and when the cards will be distributed, determine how much cards or packages or cards will cost, and the like. In this manner, publishers have the ability to control various aspects of card design and distribution in order to suit particular business needs of the publisher. For instance, a publisher may publish a relatively small number of cards related to an event, and release of the cards to the public may be timed to coincide with that event. For example, a collection of cards may be produced having content reflective of an event such as a sporting event or movie, and availability of the cards to users may be controlled based on the date of the even or release of the movie. Control of the cards related to a particular event or content may be selected to promote other forms or sources of media related to the same event/content. For example, by publishing only a defined number of cards (e.g., small number), the publisher may indirectly promote the movie as users desiring the cards discuss, write about, blog about, and otherwise create exposure for the publisher regarding the cards. Alternatively, a publisher may publish enough cards to satisfy most or all fans, or may publish any number determined by the publisher. Control of various aspects of cards can be maintained by the publisher, by another entity on behalf of the publisher, by one or more entities related to the content of the cards, such as celebrities featured in the cards, by a provider of services that utilize one or more embodiments of the invention, and/or various aspects of control may be allocated among several entities.

In another aspect of the present invention, information regarding activities involving electronic trading cards can be collected and/or maintained. Such information on card activity may relate to transactions involving electronic trading cards, such as the specific cards involved, card type, card rarity, ownership (e.g., current ownership, title history, etc.), any value units involved in the transactions (e.g., monetary or otherwise), and the like. The information may be used to provide users and publishers information of interest, such as current market values for electronic trading cards, projected future values, past revenue derived directly or indirectly from publishing electronic trading cards, future projections of revenue that may be derived from publishing electronic trading cards, and the like. In this manner, consumers and publishers can use the information to inform future card-related activities.

As noted above, techniques described and suggested herein include systems and methods for implementing an integrated platform as described herein. In one embodiment, an integrated platform for facilitating the trading of electronic trading cards (also referred to as “electronic cards” or simply “cards”) among users is disclosed. The integrated platform, through the processes it employs, facilitates user activities among users of electronic trading cards. Activities facilitated by the integrated platform include, but are not limited to, collecting cards, purchasing cards, searching for cards and potential partners for transactions, publishing cards, playing games involving cards, and the like. In an embodiment, social networking techniques are utilized in order to enhance the user experience. For instance, the topology of a social network may be utilized to identify cards that may interest users and potential transactions that may be mutually beneficial to multiple users.

The integrated platform, in an embodiment, provides publishers of all sorts the ability to publish their own electronic trading cards and control aspects of the cards' display and distribution. For instance, publishers may control content for electronic trading cards, how the cards are to be packaged, how the cards are to be distributed, when the cards are to be distributed, and the like. Because publishers have control over aspects of cards and their distribution, including the rarity of cards, publishers are able to play a significant role in market dynamics in connection with their cards. As an example, publishers may publish a limited collection of cards to coincide with the release of movies, television shows, concerts, and other events related to the content of electronic trading cards.

The integrated platform may be used to monitor card-related activities in order to enhance the experience of both users and publishers. For instance, social networking techniques may be used to provide users with cards that may interest them, such as cards owned by their friends and acquaintances or cards owned by others who own similar cards. As another example, statistics regarding card transactions may be aggregated in order to provide both users and publishers with predictions on future card transactions, such as projections of card value and expected revenue. Other information may be provided in order to encourage card-related activities among users. Users, in an embodiment, are able to view information such as who has the most cards, who has the most valuable collections, and the like. This information may provided in connection with all users, groups of users (such as users in a geographic region, users satisfying one or more criteria on a social network, and the like).

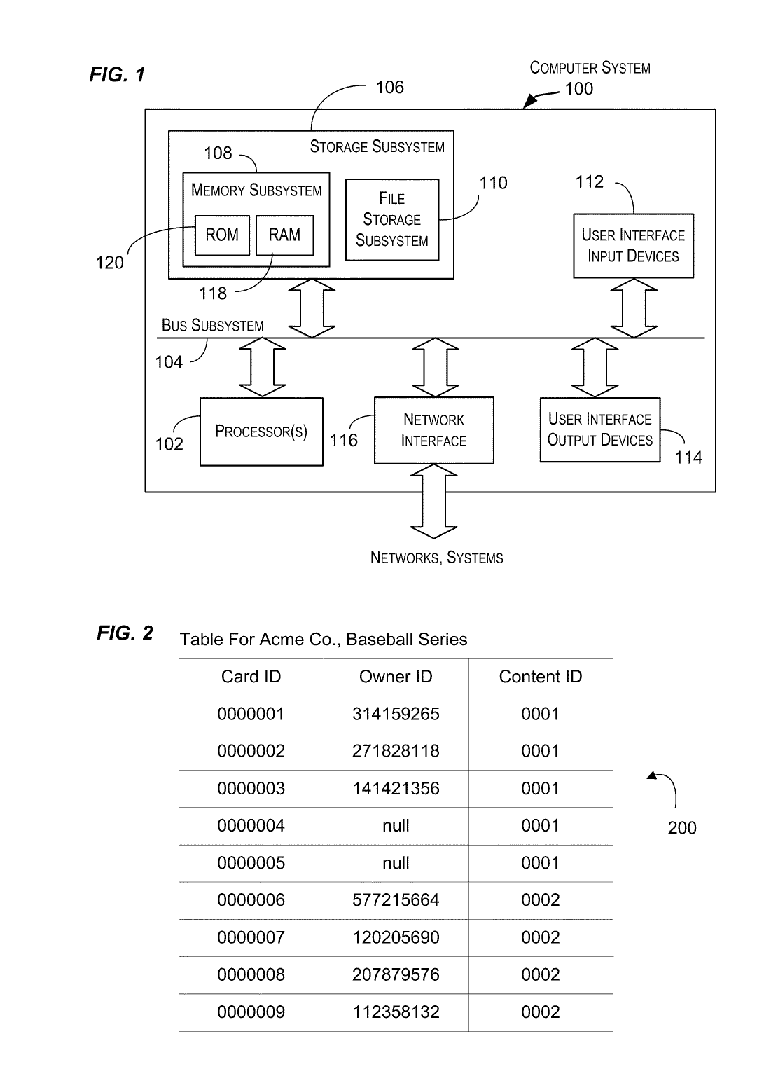

FIG. 1 is a simplified block diagram of a computer system 100 that may be used to practice the integrated platform described herein. In various embodiments, computer system 100 may be used to implement any of the systems illustrated in FIG. 1 and described above. For example, computer system 100 may be used to implement one or more components of a system that is used to practice the invention. The system 100 may, for instance, participate in maintenance of one or more databases used in electronic card management. As another example, the system 100 may participate in implementation of the invention as a web server, application server, database server, or other computing device that facilitates user participation with electronic cards. The system 100 may also operate as a client user system, such as a personal computer, mobile computing device, tablet computing device, and the like. As shown in FIG. 1, computer system 100 includes a processor 102 that communicates with a number of peripheral subsystems via a bus subsystem 104. These peripheral subsystems may include a storage subsystem 106, comprising a memory subsystem 108 and a file storage subsystem 110, user interface input devices 112, user interface output devices 114, and a network interface subsystem 116.

Bus subsystem 104 provides a mechanism for enabling the various components and subsystems of computer system 100 to communicate with each other as intended. Although bus subsystem 104 is shown schematically as a single bus, alternative embodiments of the bus subsystem may utilize multiple busses.

Network interface subsystem 116 provides an interface to other computer systems and networks. Network interface subsystem 116 serves as an interface for receiving data from and transmitting data to other systems from computer system 100. For example, network interface subsystem 116 may enable a user computer to connect to the Internet and facilitate communications using the Internet.

User interface input devices 112 may include a keyboard, pointing devices such as a mouse, trackball, touchpad, or graphics tablet, a scanner, a barcode scanner, a touch screen incorporated into the display, audio input devices such as voice recognition systems, microphones, and other types of input devices. In general, use of the term “input device” is intended to include all possible types of devices and mechanisms for inputting information to computer system 100.

User interface output devices 114 may include a display subsystem, a printer, a fax machine, or non-visual displays such as audio output devices, etc. The display subsystem may be a cathode ray tube (CRT), a flat-panel device such as a liquid crystal display (LCD), or a projection device. In general, use of the term “output device” is intended to include all possible types of devices and mechanisms for outputting information from computer system 100. Content may be output by computer system 100 using one or more of user interface output devices 114.

Storage subsystem 106 provides a computer-readable storage medium for storing the basic programming and data constructs that provide the functionality of the present invention. Software (programs, code modules, instructions) that, when executed by a processor, provide the functionality of the present invention may be stored in storage subsystem 106. These software modules or instructions may be executed by processor(s) 102. Storage subsystem 106 may also provide a repository for storing data used in accordance with the present invention. Storage subsystem 106 may comprise memory subsystem 108 and file/disk storage subsystem 110.

Memory subsystem 108 may include a number of memories including a main random access memory (RAM) 118 for storage of instructions and data during program execution and a read-only memory (ROM) 520 in which fixed instructions are stored. File storage subsystem 110 provides a non-transitory persistent (non-volatile) storage for program and data files, and may include a hard disk drive, a floppy disk drive along with associated removable media, a Compact Disk Read-only Memory (CD-ROM) drive, an optical drive, removable media cartridges, and other like storage media.

Computer system 100 can be of various types including a personal computer, a portable computer, a workstation, a network computer, a mainframe, a kiosk, a server, a tablet computer, an electronic book reader, a mobile device, or any other data processing system. Due to the ever-changing nature of computers and networks, the description of computer system 100 depicted in FIG. 1 is intended only as a specific example for purposes of illustrating an embodiment of the computer system. Many other configurations having more or fewer components than the system depicted in FIG. 1 are possible.

The computer system 100 described above, or variations thereof, or multiple computer systems, may be utilized in order to implement various embodiments of the invention. In addition, executable instructions for practicing the invention may be collectively stored on one or more computer-readable storage media. One or more computer systems that may include one or more processors may collectively execute the instructions or otherwise be configured to implement embodiments of the invention.

In one embodiment, electronic cards are provisioned according to ownership limits. An electronic card (also referred to as an electronic item), in an embodiment, includes electronic content with which transactions may be completed according to a physical item trading metaphor, as described in more detail herein. For instance, the electronic trading card may be traded, bought, sold, and/or otherwise transacted as if the trading card was a physical item. Similarly, members of a set of electronic trading cards may be traded, bought, sold, and/or otherwise transacted such as if the set were a finite set of items that cannot be increased (perhaps due to publishing only a limited amount of items in the set). As another example, sets of electronic cards may be defined and transacted according to a trading card set metaphor. For instance, defined sets of electronic items may be centrally managed so that, while content and/or other information of any particular electronic item may (or may not) be reproduced, the number of electronic items in the set remains limited to a predetermined number. Thus, unlike electronic content in general, management of the electronic items in accordance with the present disclosure may be performed to maintain rarity characteristics of the electronic items as if they were physical items.

An electronic trading card may have an identifier, that can be associated with an owner. The content may also be associated with other information. Content may be information, that when rendered and displayed on a display device, resembles a physical trading card. However, while the present disclosure uses the illustrative example of trading cards, content can, when displayed, take any applicable form. Examples of other content include video files, audio files, articles, electronic books, general electronic documents, combinations of different types of content, streamed information, and the like. The content may represent other physical items, such as books, any physical collectible item, or, generally, may take any form and need not represent any physically existing thing.

In an embodiment, electronic cards are each assigned a unique identifier. Provisioning a card may include associating the unique identifier with an owner. Multiple electronic cards may include the same, or substantially the same, content. For instance, numerous unique identifiers may be used for corresponding electronic cards, all of which include the same or substantially the same content. Multiple electronic cards may include the same image of a baseball player, but be assigned different unique identifiers. In addition, different electronic cards may include different content. For example, two different electronic cards may include images of two different baseball players. In this manner, electronic versions of baseball cards (or, generally, trading cards or other content) are provided, with each card assigned a unique identifier.

Electronic cards (also referred to herein as “cards,” unless otherwise stated or clear from context), in an embodiment, are provisioned to individual users or other entities, such as electronic stores or other entities (generally, users). Provisioning of the electronic cards may be done in any suitable manner. In one embodiment, a relational database is used to associate identifiers of electronic cards with identifiers of users. For instance, a table may include one row for each electronic card where the values in one column correspond to electronic card identifiers and values in another column correspond to identifiers of owners. Thus, in this example, a particular row of the table would associate the identifier of an electronic card with an identifier of the card's owner. Other columns may correspond to other information. Additionally, any suitable data structure or other mechanism for associating electronic cards with owners may be used.

FIG. 2 shows an illustrative example of a portion of a representation of a database table 200 for associating identifiers of electronic cards with identifiers of owners. In this particular example, the table 200 includes three columns, a “Card ID” column, an “Owner ID” column, and a “Content ID” column. In this example, values in the Card ID column correspond to unique identifiers of electronic cards. In an embodiment, values in the Card ID column are integers, although other values, such as strings, or combinations of values may be used. Values in the Owner ID column correspond to unique identifiers of entities (such as people). As with the Card ID column, values in the Owner ID column are integers, but may be other values, such as strings representative of usernames or electronic mail addresses. As shown in the illustrative table 200, values in the Owner ID table may be null. A null value may indicate that a corresponding electronic card has not yet been associated with an owner or, for some reason, an owner has ceased to become associated with the electronic card without a new owner being associated with the electronic card. For instance, an owner of an electronic card may have cancelled a user account without first having assigned his or her cards to another user.

Values in the Content ID column, in this example, correspond to instances of content, such as images or sets of images of the corresponding electronic card. In the example of baseball cards, for instance, the value “0001” in the Content ID column may correspond to an image of a particular baseball player. Generally, content corresponding to values in the Content ID table can be any content, which may include picture files, audio files, video files, text, other content, and combinations thereof. As shown in the illustrative table 200, in an embodiment, values in the Content ID column are not necessarily unique, although they can be. For instance, electronic cards with identifiers 0000001, 0000002, 0000003, 00000004, and 0000005 all correspond to the same content, such as content relating to the same baseball player.

As noted above, electronic cards are provisioned according to ownership limits. A set of electronic cards, in an embodiment, includes a finite number of electronic card identifiers. In this manner, a set of electronic cards is limited to the number of identifiers for the set. For instance, referring to the table 200 of FIG. 2, a maximum of five owners can be associated with electronic cards that correspond to the content identified in the third column by 0001 because only five different electronic card identifiers correspond to the value 0001. For more than five owners to be associated with the electronic cards that correspond to the content identified in the third column by 0001, in an embodiment, partial ownership of cards may be allowed.

It should be noted that the table in FIG. 2 is provided for the purpose of illustration and fewer or more information about cards may be stored. For instance, the database table 200, or other tables, or any mechanism for storing data, may include information corresponding to other characteristics of cards. Example information includes information identifying previous owners of cards, information regarding a card's condition, information regarding signatures received the card, information regarding past transactions for the card, information regarding series to which cards belong (such as a series of baseball cards for a particular season by a particular publisher), and other information.

In an embodiment, cards are provisioned by assigning owners to the cards. Assignment of an owner to an electronic card may be accomplished, for example, by associating in a data store an identifier of the electronic card with an identifier of an owner, or several identifiers of multiple owners that each have partial ownership. As noted, association of electronic card identifiers and owner identifiers may be accomplished using relational database tables or other mechanisms. In FIG. 2, for instance, an electronic card with identifier 0000001 has been associated with an owner identified by 314159265. Electronic cards may be provisioned all at once, such as to a distributor of cards or owners identified by a distribution list, or incrementally, or, generally, in any suitable manner. For instance, an entity utilizing an embodiment of the invention may provision cards to users that sign up for the cards on a first come, first server basis.

In an embodiment, ownership (or partial ownership) of electronic cards may be transferred to different owners. In an embodiment, transferring ownership of an electronic card from one owner to another includes associating the electronic card with a new owner. In the example of a relational database, a value in a column corresponding to an owner identifier and in a row corresponding to the electronic card is changed from an identifier of the previous owner to the new owner. For instance, if the owner with identifier 141421356 in FIG. 2 transferred ownership to a user with identifier 314159265, the value of the third row of the second column of the table 200 would be changed from 141421356 to 314159265. Generally, any ways of changing the association of an electronic card from a previous owner to a new owner (or to/from multiple joint owners) may be used.

Appendix B of provisional application No. 61/364,726, entitled “Techniques for Provisioning Content,” noted above and incorporated herein by reference, provides an example entity relationship diagram (ERD) demonstrating a schema for a relational database that may be used in accordance with an embodiment. The diagram includes a collection of objects representative of various tables that may be included in a relational database. Each table may store various information regarding cards and card-related activities, as indicated in the diagram by the names provided in the objects. A lower portion of each object represents of columns that may appear in each table. Arrows connecting the objects demonstrate relationships among the various tables. The diagram in Appendix B is provided for the purpose of illustration, and other ways of storing data may be utilized. For instance, a higher or lower degree of normalization of the tables shown in Appendix B may be used.

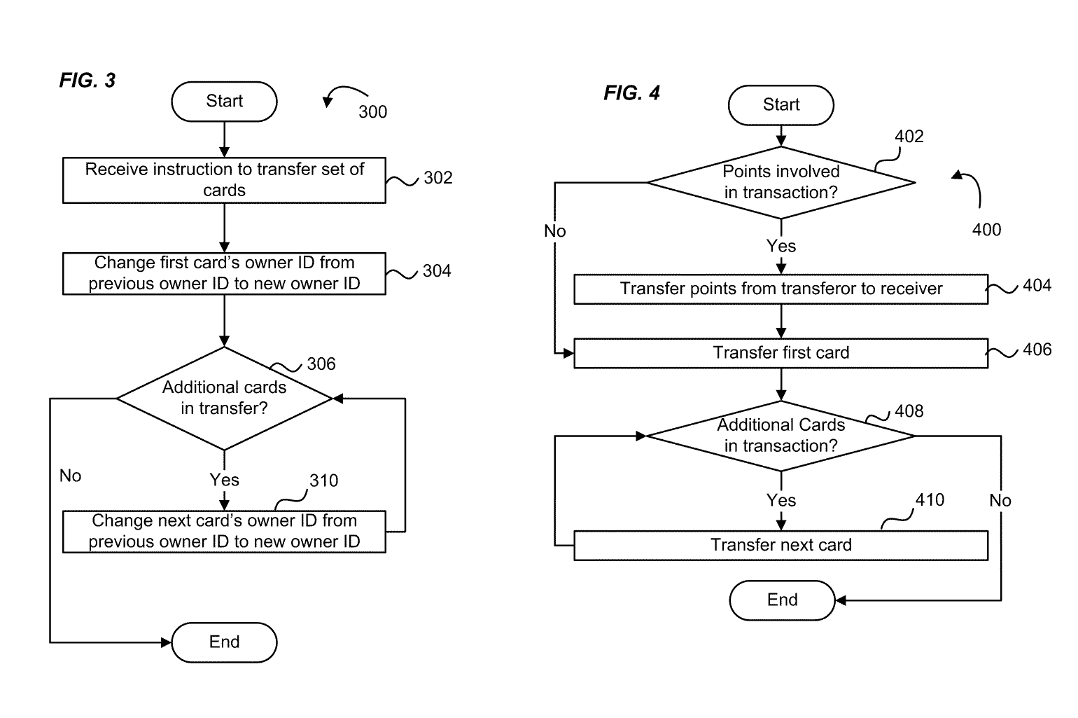

FIG. 3 shows a flowchart for an illustrative example of a process 300 for transferring ownership of an electronic card, in accordance with an embodiment. The process 300, or any process described herein or variation thereof, may be performed under the control of one or more computer systems that are collectively configured with executable instructions. Executable instructions may be stored collectively on one or more computer-readable storage media. In an embodiment, an instruction to transfer a set of cards is received 302. The instruction may be received responsive to one or more events, such as user input indicative of an intent to transfer the set of cards. Once the instruction is received, in an embodiment, a first card from the set of cards is identified and an identifier of an owner associated with the first card is changed 304 to an identifier of a new owner. The identifier of the previous owner may be stored in a data store in order to maintain a history of ownership of the first card. In an embodiment, a determination is made 306 whether there are additional cards involved in the transfer. If there are additional cards involved in the transfer, then a next card of the set of cards is identified and an identifier of the owner of the next card is changed 306 to an identifier of the new owner. Again, information identifying the previous owner may be stored in a data store in order to maintain a history of ownership of the card. Upon changing ownership information of the next card, a determination is made 306 whether there are additional cards in the transfer and, if there are, then the process 300 continues as described above. One or more messages (such as electronic mail messages or other messages) may be sent to the previous and new owners of the cards involved in the transfer.

Various applications may be used to facilitate the transfer of electronic cards from one owner to another. In one embodiment, an application that maintains ownership information and electronic card information (and possibly other functions) is integrated with one or more social networking applications. An illustrative example of such integration appears in Appendix A of provisional application No. 61/364,726, entitled “Techniques for Provisioning Content,” noted above and incorporated herein by reference. Identifiers of owners of electronic cards may be associated with identifiers of users of the social network. In this manner, users may utilize social network accounts in order to view, purchase, trade, and otherwise interact with electronic cards.

In an embodiment, electronic cards may be purchased with points. Users may acquire points in various ways. In one example, users are able to purchase points using actual currency. In another example, users may acquire points in exchange for completing certain tasks, such as playing (perhaps winning) games, winning contests, winning raffles, opening accounts, completing surveys, purchasing items, traveling, and, generally, in any manner. In another example, advertisers purchase points from an operator of a system that implements embodiments of the present disclosure, and distribute them to users in various ways connected with advertising, such as with the purchase of the advertisers' products, services, or other items. Acquired points then are able to be used as currency for purchasing electronic cards. Users may use their points to purchase an electronic card by transferring points to the seller of an electronic card. The transfer of points may include updating in a data store values that correspond to points of users. For instance, if a buyer purchases an electronic card from a seller of the electronic card for one hundred points, in an embodiment, a value corresponding to the buyer's points is reduced by one hundred while the value corresponding to the seller's points is increased by one hundred. In the case of partial card ownership, a buyer or seller's points may be decreased or increased appropriately based upon their percentage of ownership in the conveyed electronic card.

FIG. 4 shows a flowchart for an illustrative example of a process 400 for completing a transaction in connection with a set of cards. In an embodiment, a determination is made 402 whether a transaction involves a transfer of points. If points are involved in the transaction, points are transferred 404 to a receiver of the points. Once the points are transferred, a first card involved in the transaction is transferred 406, although points and cards may be transferred in a different sequence than illustrated or simultaneously in various embodiments. Depending on the specific transaction being completed during performance of the process 400, transfer of the first card (or any card) may be from the receiver to the owner from whom points were transferred, or from the owner from whom the points were transferred to the receiver, or otherwise. Transfer of card ownership may be performed in accordance with the process 300 described above in connection with FIG. 3 or in any suitable manner. Once ownership of the first card is transferred, in an embodiment, a determination is made 408 whether there are additional cards involved in the transaction. If there are additional cards involved in the transfer, then ownership of the next card is transferred 410 and another determination is made 408 whether additional cards are involved in the transaction and the process 400, in an embodiment, continues as above.

As noted, the purchase of electronic cards may be performed in a variety of environments. In one example, a user may search for owners of an electronic card he or she desires and offer a certain amount of points to one or more of the owners. The offer may include an indication of a number of points and/or identifiers of one or more electronic cards for trade. An owner who made an offer may accept the offer, reject the offer, or reject the offer and provide a counter offer, which may identify a number of points or other electronic cards. Electronic cards may also be gifted or auctioned. Auctions for cards may proceed in any number of ways. For instance, an electronic card may be sold to a user who offers the most value for the card, such as the highest number of points. Owners of electronic cards associated with the same content may offer to sell their cards to a buyer and the buyer may purchase the electronic card from the owner who provided the offer of lowest value. Generally, any environment that facilitates transfer of electronic cards may be used.

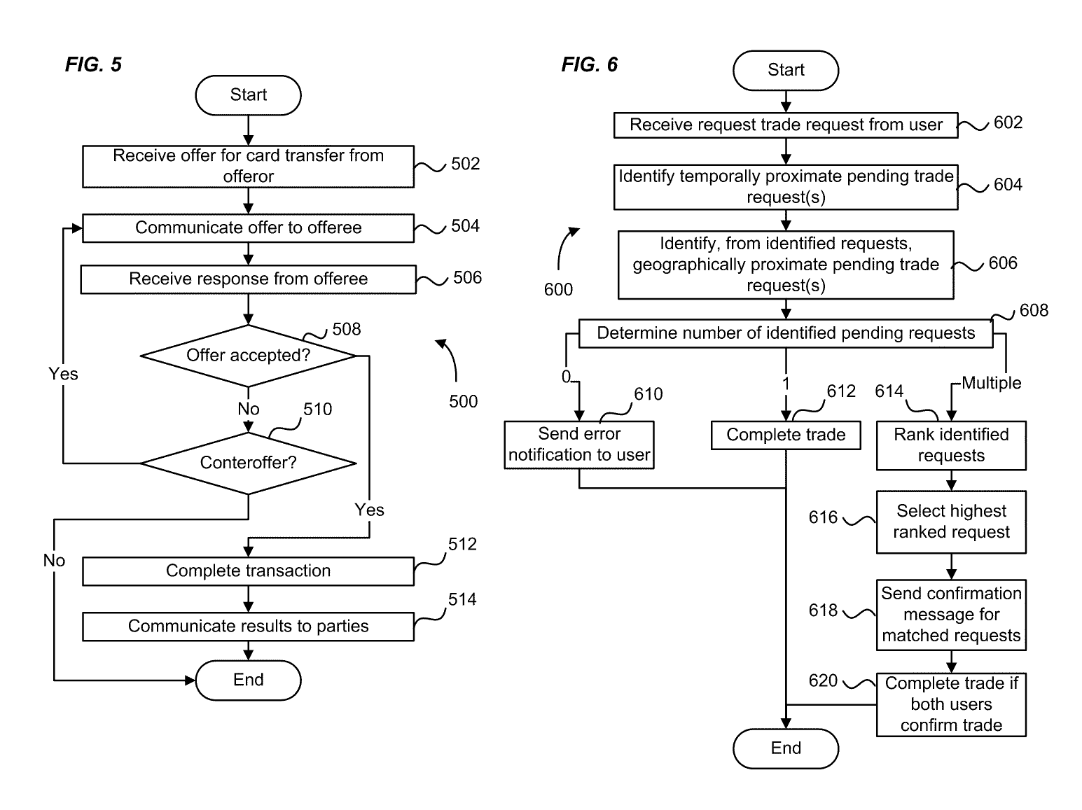

FIG. 5 shows a flowchart for an illustrative example of a process 500 for facilitating a transaction between two entities. In an embodiment, an offer for a card is received 500 from an offeror. The offer may be an offer to buy, sell, or trade one or more cards. In an embodiment, the received offer is communicated 504 to the offeree. Communication of the offer may be done in one or more ways, such as by sending an electronic mail message that communicates the offer the existence thereof, an instant message, posting a message to an account of the offeree, or in any suitable manner. If the offeree responds, in an embodiment, a response is received 506 from the offeree. The response from the offeree may be made in any suitable manner. In an embodiment, the offeree is allowed to communicate his or her response through an interface provided over a communications network, such as through a web page interface of a web page. A determination is made 508 whether the offeree has accepted the offer and, if the offer has not been accepted, a determination is made 510 whether the offeree has made a counteroffer. If the offer has been accepted, then the transaction identified in the offer is completed, such as in a manner described above in connection with FIG. 4, and the results of are communicated to the offeror and offeree. If the offeree provided a counteroffer, then the offeree becomes the offeror and the offeror becomes the offeree and the counteroffer is communicated 504 to the new offeror. Offers and counteroffers may continue until the parties agree to terms or decide to not entertain any further offers.

As with any process described herein, variations to the process 500 of FIG. 5 are contemplated as being within the scope of the present disclosure. For instance, users may set conditions for offers that they will accept. If an offer fulfills conditions set by an offeree, then a transaction may be completed automatically without the offeree being required to explicitly confirm acceptance of the offer. Additionally, in an embodiment, users are able to change settings that control how offers are made and received. For instance, an owner of an electronic card may identify that he or she does not wish to receive offers below a threshold value. The threshold value may be the same for all electronic cards of the owner, or may vary among the owner's electronic cards. Additionally, in an embodiment, a user is able to specify that certain offers are accepted automatically while other offers must be reviewed. As another example, in an embodiment, a user is able to specify parameters for offers that he or she is willing to make or willing to accept. A data store may be analyzed in order to match offers with users willing to accept the offers. For instance, a user may indicate that he or she would be willing to receive a certain amount of points and/or certain electronic cards in exchange for one or more electronic cards and/or points. Offers may be simple (consisting of an electronic card or points) or complex (comprising multiple electronic cards and/or points and/or other consideration). In another example, users can set parameters for notifications such that, if an offer to sell a certain type of electronic card becomes available, users may receive notifications that enable the users to make offers for the offered cards.

Users of cards may be able to purchase packs of electronic cards and trade packs of electronic cards, where a pack of cards is a set of electronic cards. A user, for instance, may purchase every electronic card of a series. A user may also purchase a number of electronic cards and the content with which the electronic cards are associated may become known to the user only subsequent to the purchase. For instance, a user may purchase a pack of twenty five electronic baseball cards, each electronic baseball card being associated with a particular baseball player. The user may not know which baseball players the electronic cards are associated with until he or she completes a purchase of the pack. Also, a user may receive two or more electronic cards associated with the same content (such as the same baseball player) when receiving a pack. A user, in an embodiment, is required to provide input to “open” the pack and then receive information identifying the content with which the electronic cards in the pack are associated with. In this manner, if a user does not open a purchased pack, he or she may sell the pack, trade the pack, or otherwise complete a transaction with the pack. The pack may be transferred until an owner of the pack opens the pack. When a pack is opened, in an embodiment, the pack cannot be transferred again without transfer of information identifying the electronic cards in the pack.

FIG. 6 shows a flowchart of an illustrative process 600 for facilitating transactions involving cards. The process 600 may be especially useful for facilitating trades initiated using mobile devices. For instance, a user may, using his or her mobile device, identify a card he or she wishes to trade for another card identified on another user's mobile device. The users may collectively indicate that they wish for a trade to occur in order to cause the trade to occur. In an embodiment, the users may cause the trade to occur without each identifying what he or she will receive in return. Turning to the specifics of the illustrative process 600, in an embodiment, a trade request 602 is received from a user. A trade request, in an embodiment, is an electronic message that identifies information relating to a trade. Information in the trade request may include, for instance, a time stamp associated with the trade request's initiation, information such as global positioning system (GPS) coordinates that identifies the user's location when the request was initiated, one or more cards to be offered by the user in the trade, a value for a number of points to be offered by the user in the trade, and other information.

When two users who intend to complete a transaction with one another initiate trade requests, one or more appropriate algorithms may be utilized in order to match one user's trade request with the trade request of the other user intending to engage in the transaction. Algorithms used to match trade requests utilize data about the trade requests in order to determine which trade request is most likely to match another. For instance, when the user's trade request has been received 602, in an embodiment, pending trade requests that are temporally proximate to the user's trade request are identified 604. The pending trade requests may be other trade requests that have been received from other users, such as other users intending to engage in other transactions. The pending trade requests may identify all pending trade requests that have a timestamp within a threshold time, such as several seconds, of a timestamp of the user's trade request. In an embodiment, geographically proximate pending trade requests are identified 606 from the identified temporally proximate pending trade requests. For instance, pending trade requests that have corresponding GPS coordinates within a threshold radius (such as one kilometer) of GPS coordinates of the user's trade request may be identified.

In an embodiment, once a preliminary set of pending trade requests are identified, a determination is made 608 of the number of pending trade requests. If there are no pending trade requests identified, then an error notification may be sent 610 to the user. The error notification may be an electronic message with content explaining that the attempted transaction was unsuccessful. If exactly one pending trade request has been identified, in an embodiment, then the identified trade request is considered to complement the user's trade request and the transaction is completed 612. For instance, any points and/or cards identified for the transaction by the user are transferred to an entity that initiated the identified trade request. Similarly, points and/or cards identified for the transaction by the entity that initiated the identified trade request are transferred to the user.

If, however, multiple trade requests are identified, then one or more algorithms may be used to identify a trade request that is most likely to complement the user's trade request. In an embodiment, the identified trade requests are ranked 614 according to one or more criteria. For instance, the identified trade requests may be ranked based at least in part on geographical proximity to a location identified in the user's trade request, where trade requests with corresponding locations closer to a location of the user's trade request are ranked higher than trade requests with corresponding locations farther from the location of the user's trade request. In another embodiment, scores are calculated for the identified trade requests and the scores are used to rank the identified trade requests. A score for an identified trade request may be calculated based at least in part on information of the user's trade request and information of the identified trade request. Information related to the trade requests may influence the scores in various ways. For instance, closer geographical and/or temporal proximity to geographical and/or temporal locations associated with the user's trade request may influence a score higher. As another example, trade requests involving cards of the same series as the user's trade request may be ranked higher than trade requests involving cards from different series. In addition, certain aspects of the user's trade request and the identified trade requests may be used only if other aspects are inconclusive. For instance, if geographical proximity is considered to be determinative, then temporal proximity may not affect a score. Generally, any suitable method for matching pending trade requests with the user's trade request may be used.

When the pending trade requests are ranked, the highest ranked trade request is selected 616, in an embodiment, and a confirmation message 618 may be sent to the user and the entity that initiated the highest ranked trade request. The confirmation message for each user may be an electronic message that includes one or more interactive interface elements that allow the user to confirm (by sending an electronic response to the message) that he or she indeed intended a transaction identified in the confirmation message. In an embodiment, if the user and the entity that initiated the highest ranked trade request provide positive responses to their respective confirmation messages, then the transaction is completed 620. If one of the user and the entity that initiated the highest ranked trade request do not provide a positive response to their respective confirmation message, then the transaction may not be completed.

In an embodiment, when electronic cards are published, the content associated with the electronic cards is not allowed to be changed by the publisher. In this manner, errors made in the content (such as misspelling of a baseball player's name or incorrect player statistics) are preserved as electronic cards are transferred. A card with an identified error may cause the value of the electronic card to increase since such cards may be rare. A publisher, in an embodiment, may provision new cards with which errors have been corrected, but without replacing the electronic cards with the errors. In addition, in an embodiment, publishers may intentionally create errors in the content of electronic cards. The intentional errors may be to intentionally mimic errors made in physical trading cards, such as a picture being flipped about an axis, or other errors. Statistical distributions of errors in physical trading cards may also be mimicked.

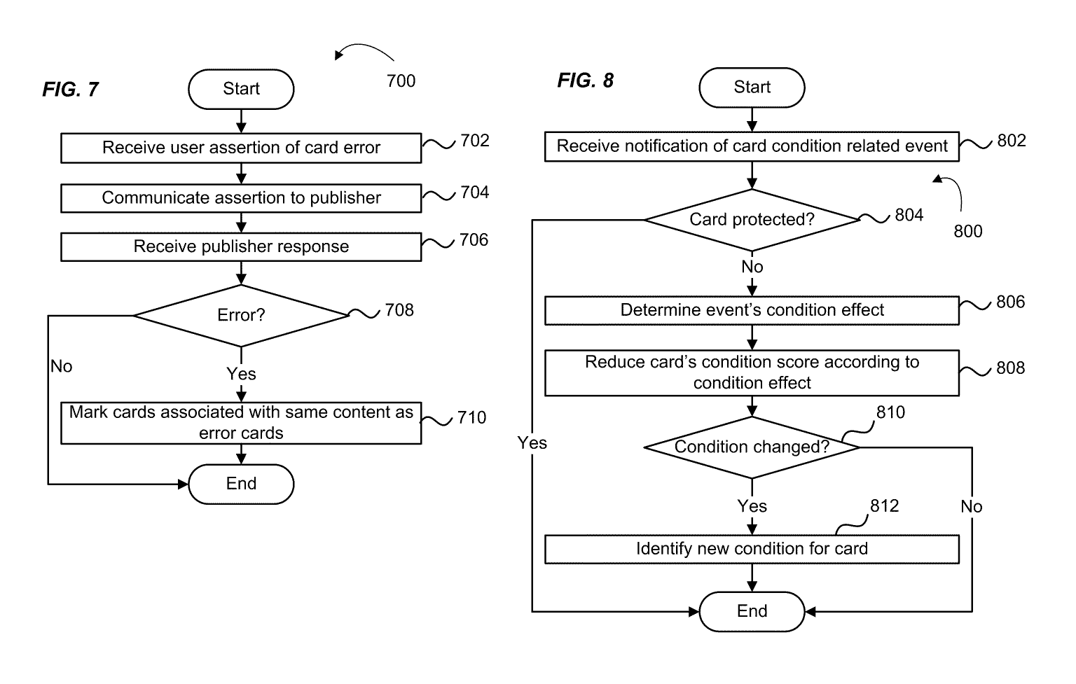

Information related to electronic cards that is stored may include information that identifies cards as error cards. FIG. 7 shows a flowchart for an illustrative process 700 for identifying cards as error cards. In an embodiment, a user notices a potential error in a card (whether the error was intentional or unintentional) and communicates an assertion of the error. The assertion may be an electronic message that identifies a particular card (or group of cards) and that has a user-generated explanation of the error. Communication of the assertion by the user may be accomplished in any suitable manner, such as by the user sending an electronic mail message or by communicating the assertion through a graphic interface that has been provided over a communications network. In an embodiment, when the assertion is received 702 from the user, the assertion is communicated 704 to a publisher of the card(s) involved in the assertion. The publisher may review the assertion in order to determine whether there is indeed an error and communicate the determination to an operator of an entity performing the process 700, such as an entity that provides applications and interfaces for trading electronic cards. When the publisher's response is received 706, a determination is made 708 whether there is indeed an error in the card. In an embodiment, the publisher's response is an electronic message that identifies whether the assertion of the error is correct. If the publisher's response indicates that there is an error in the card, then cards associated with the same content are identified 710 as error cards in a data store. For instance, a column in a relational database table that is dedicated to storing information regarding error cards may have values modified in order to identify cards marked as error cards. Also, information regarding an explanation of the error, such as text and/or other content describing the error may be stored and provided to users upon user requests.

In an embodiment, each electronic card has an associated condition value. The condition value may affect the appearance of an electronic card's content when displayed on a display device. For example, an electronic card with a high condition value may appear flawless when displayed whereas an electronic card with a lower condition value may appear to have flaws, such as scratch marks, blurry portions, bent corners, dirty spots, and/or other flaws. The number and/or magnitude of flaws may be correlated with the condition value. Additionally, a calculated value for an electronic card may depend on the condition value.

The condition value for a card may change upon the occurrence of an event. Possible events include, but are not limited to, transfer of an electronic card from one person to another, a view by one user of another user's card, view of a user of his or her own card, the passage of an amount of time, random events, and the like. Owners of cards may, through user input, destroy their own cards (or perhaps others' cards). For instance, an owner of several cards associated with the same content may destroy several of the cards in order to increase the market value of the remaining cards associated with the content. In one example, users have associated carefulness scores. If someone with a high carefulness score views another person's electronic card, the electronic card's condition value may change little, if at all. However, if someone with a low carefulness score views another person's electronic card, the electronic card's condition value may change more significantly. The amount an electronic card's condition value changes may be correlated to the carefulness score of a user who has viewed the card. In an embodiment, an electronic card's condition value may only change in one direction.

Users, in an embodiment, are able to take measures to protect their electronic cards' condition values. For instance, in one example, users are able to purchase virtual protective sleeves for their electronic cards. An event with respect to an electronic card with a sleeve may affect the electronic card's condition value less than it would have had the electronic card not had a sleeve. Virtual electronic sleeves may be transferred with cards, in an embodiment.

FIG. 8 shows a flowchart for an illustrative process 800 for managing cards' conditions, in accordance with an embodiment. As noted, various events may have the potential to affect a card's value. In an embodiment, when an event occurs, a notification is generated and received 802. A notification may be an electronic message that includes information relating to the event, such as an identifier of a card associated with the event, one or more identifiers of users associated with the event, information identifying an event type, the time the event occurred, and the like. The notification may be generated by a computing device involved in the occurrence of an event, such as a server used in connection with a system that implements one or more of the embodiments described herein, or variations thereof. When the notification is received, a determination is made 804 whether the card is protected. For instance, if an owner of the card has purchased or otherwise acquired a sleeve for the card, then the determination may be that the card is protected. If an owner of the card has not purchased or otherwise acquired a sleeve for the card, the determination may be that the card is not protected. In an embodiment, no action is taken if the card is protected.

If the card is not protected, then a determination is made 806 of the event's condition effect. A condition effect, in an embodiment, is a value that indicates the magnitude of the event on the card's condition. In the illustrative example of FIG. 8, cards have condition scores. Accordingly, when the event's condition effect is determined 806, the card's condition score is reduced 808 according to the condition effect. In one embodiment, the condition effect value is subtracted from a current condition score for the card, although other techniques may be used, such as multiplying the condition score by an amount that reduces the condition score, or otherwise adjusting the condition score. Cards, in an embodiment, can have one or a finite number of conditions, each condition corresponding to a range of condition scores. Conditions may be identified as one of the following, ordered from better to worse: perfect, mint, excellent, very good, good, poor, very poor, destroyed. Other scales and identifiers of levels in the scales may also be used.

When the card's condition score is reduced 808, in an embodiment, a determination is made 810 whether the card's condition has changed. For instance, a determination may be made whether the condition score has changed enough to cause the condition of the card to change, such as from perfect to mint, perfect to excellent, mint to destroyed, and the like. If the condition has changed, then a new condition for the card may be identified 812. Identification of the card's condition may include changing a condition value in a data store for the card, such as in an appropriate location of a relational database table associated with the card.

As electronic cards are transacted among various users, statistics about the transactions may be maintained. For example, in an embodiment, records of electronic card ownership are maintained. For instance, a relational database table corresponding to an electronic card may include a row that identifies each owner of the electronic card. In this manner, a history of the electronic card's ownerships may be provided to users. An electronic card's value may increase based at least in part on people that have owned the electronic card. For instance, if a celebrity has owned the electronic card at some point, the card may be more valuable than an electronic card corresponding to the same content that was not owned by a celebrity. Other statistics that may be collected include prices paid for electronic cards, trades made for electronic cards, and other statistics. Information about cards may be used in order to calculate various statistics, such as market values, returns on investments, and the like. Data for electronic cards may be analyzed and results of analysis may be provided to users. For instance, recent trades for electronic cards corresponding to the same content may be used in order to establish a market value for electronic cards. Data regarding electronic card transactions may be used to recommend cards to users. Electronic cards of one series, for instance, may be recommended to someone who expresses interest in electronic cards of another series if data indicates that users are often interested in both series.

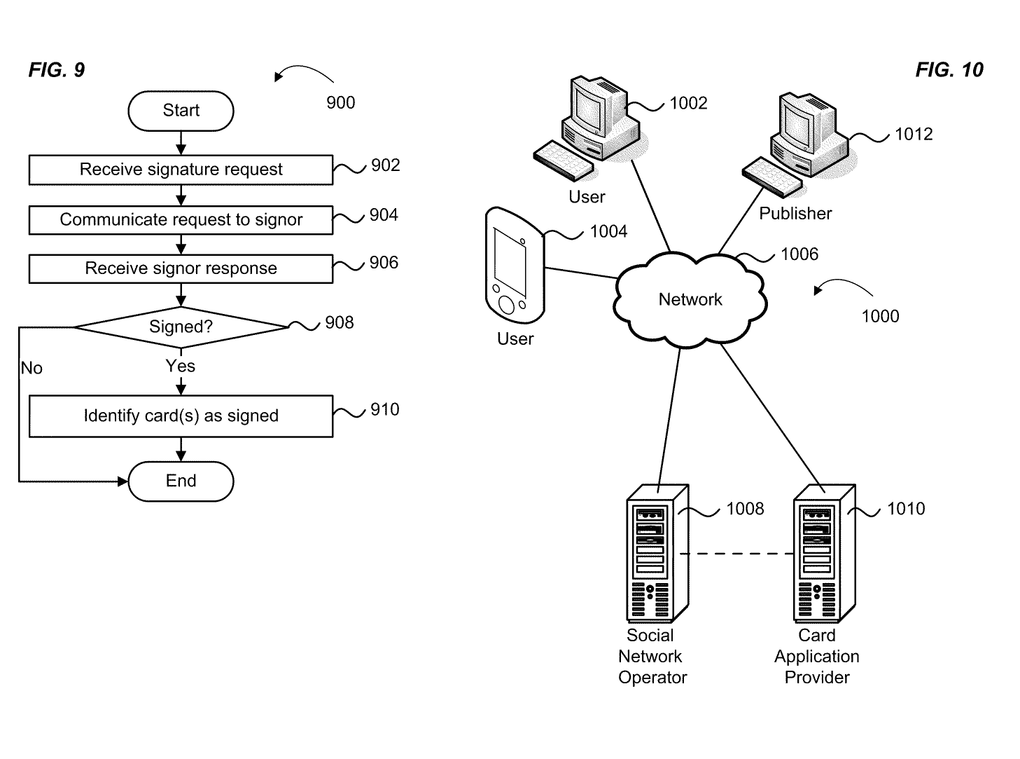

Other variations are also contemplated as being within the scope of the present disclosure. For instance, in one embodiment, users are allowed to electronically sign cards. FIG. 9 shows a flowchart of an illustrative process 900 for facilitating card signing, in accordance with an embodiment. The process 900 may begin with receipt 902 of a signature request. A signature request may be generated responsive to user input indicative of an intent to make such a request. A signature request may be an electronic message that identifies the card, a signor requested to sign the card, a requestor, and/or a personal note such as a personal request to the signor. In an embodiment, many cards are associated with people. A baseball-themed card may, for example, be associated with a particular professional baseball player. A data store may associate people with corresponding cards. An owner of a card may, through user input, request a signature from the person associated with the card. Owners of cards may also, in various embodiments, request a signature from people not associated with the cards. For instance, as a joke, an owner of a card associated with a baseball player may request that a baseball player from a rival team sign the card. An owner of a card may, as another example, request that one of his friends sign a card that is not associated with the friend. Signatures obtained may affect the value of a card, either positively or negatively, depending on the nature of the card and the nature of the person who has signed the card.

In an embodiment, the request communicated 904 to a signor associated with the request. The request may be communicated to the signor in various ways. For instance, a message may appear to the requestor on a social networking page of the signor, as an electronic mail message to the signor, and/or in any suitable manner. When the request has been received by the signor, the signor may provide a response or may ignore the request. If the signor provides a response, the signor response is received 906, in an embodiment. A signor response may be generated in various ways. In an embodiment, the signor is required to perform some task in order to “sign” the card and provide a response. For instance, the signor may be required to complete a Captcha task, provide a username and/or password, provide a signature similar to a handwritten signature using an appropriate input device, or perform some other task. The task may be a task that is impossible or difficult to perform using automated means. The response may include a personal message prepared by the signor such as “Dear Jonny, thanks for being my number 1 fan!” If/when the signor response is received, a determination is made 908 whether the response indicated that the signor signed the card. If the response indicates that the card has been signed, then the card (or possibly a set of multiple cards) is identified as signed. Indicating whether a card has been signed may be done by changing a value in an appropriate record in a data store, such as a value in an appropriate location in a relational database table. A message to the requestor may also be generated to notify the requestor that the card has been signed. When a card is identified as signed, a visual representation of the card may appear as superimposed on the content associated with the card when the content is displayed. In this manner, users viewing the card are shown that the card has been signed.

FIG. 10 shows a diagrammatic representation of an illustrative environment 1000 in which various embodiments, variations and/or combinations thereof, may be implemented. Components of the environment 1000 may utilize one or more components of the computing device described above in connection with FIG. 1. In an embodiment, users utilize various devices in order to access content from external information resources. Other devices include, but are not limited to, devices discussed above. For instance, users may use a personal computer 1002, a mobile device 1004, or other devices in order to access content over a network 1006, such as the Internet, a mobile communications network, and/or any suitable network. Content may be accessed, for instance, by sending requests to web servers of the network 1006 and receiving responses from the web servers. In an embodiment, an information resource accessed by various devices includes a social network 1008, where a social network is one or more computer systems that maintains a collection of accounts associated with users and relationships among the accounts. Users, in an embodiment, may access web pages or other content provided by the social network 1008 in order to send message to other users, play games, and perform other activities.

In an embodiment, users of the social network 1008 are able to utilize the social network 1008 to engage in card-related transactions and other activities. In an embodiment, card-related activities, such as those discussed above, are performed in connection with a card application provider 1010 which works together with the social network 1008. The card application provider 1010, in an embodiment, includes computer systems that maintain information about cards In one embodiment, users download and install an application on their devices that enable the users to engage in card-related activities. The application, in an embodiment, interfaces with an application programming interface (API) of the social network 1008 in order to utilize features provided by the social network 1008. Functions of the application may be available to users that have accessed the social network 1008, such as by requesting and receiving a web page of the social network. In an embodiment, social network accounts can be “linked” to one another subsequent to mutual agreement of the account holders. Friends, for instance, may link their respective accounts. The application may allow a user with an account to see cards owned by users having accounts linked to the account. The application may also facilitate trade-related activities and coordinate the flow of information between a user's device and the card application provider 1010.

The card application provider 1010 may utilize various algorithms in order to recommend cards to users. For instance, the card application provider 1010 may utilize a topology of at least part of the network in order to recommend cards to users. As a concrete example, if many accounts that are linked to a user's account are associated with users that own cards from a particular series, cards from that series may be recommended to the user. The card application provider 1010 may also recommend transactions, such as trades for cards among accounts that are linked together. The card application provider 1010 may also make recommendations for linking accounts based at least in part on card ownership. For instance, the card application provider 1010 may identify users that own a disproportionate amount of cards associated with content relating to a particular sports team and then make recommendations to the users that they link their accounts or link to an account dedicated to a fan club.

Also shown in FIG. 10, a publisher 1012 may communicate with the card application provider 1010 in order to utilize the card application provider 1010 to publish its cards. In an embodiment, a publisher prepares content for its cards and sends the content to the card application provider 1010 along with other information. The other information may include publishing information such as the number of card identifiers to be associated with each instance of content and information relating to the content, such as player statistics, player names, an identifier of a series to which the cards will belong, and other relevant information. If a publisher intentionally produces one or more error cards, the other information may include information that identifies which cards are error cards. An interface for an application utilized by a publisher to provide information about cards is provided in Appendix A of provisional application No. 61/364,726, entitled “Techniques for Provisioning Content,” noted above and incorporated herein by reference.

Publishers, in an embodiment, are able to provide print controls for cards. In an embodiment, users are able to order high-quality prints of their cards' content or to download high-quality images for printing themselves. A print control, in an embodiment, is a limit on the number of times a card's content may be printed. The card application provider 1010 may maintain a record of how many times a card has been printed and, if the number meets a limit set by the publisher, then prevent further printing.

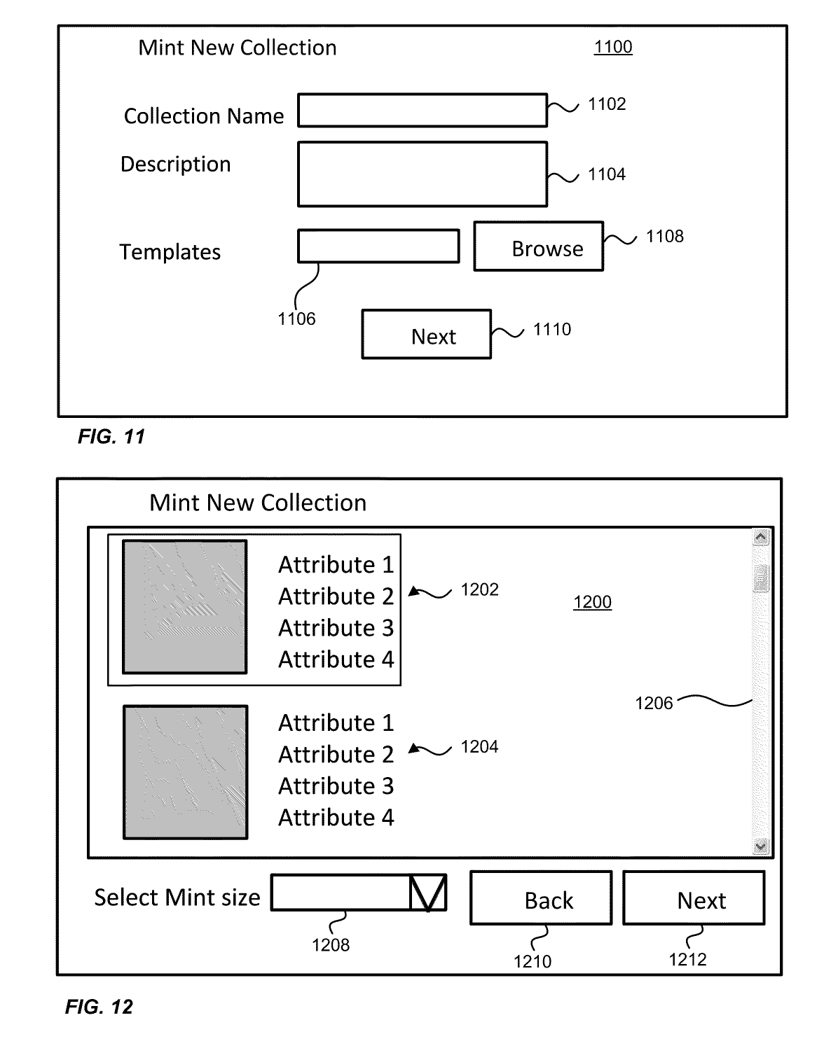

FIG. 11 shows an illustrative example of a page 1100 from an interface that allows publishers to publish cards, in accordance with an embodiment. The page 1100 (and other pages disclosed herein) may be provided to a publisher as a web page sent to the publisher over a network, such as the Internet. Other ways of providing interface pages to publishers may be used, including, but not limited to providing publishers with applications that execute locally on one or more devices of the publisher. Access to the pages may be provided upon completing a process for authentication, such as by verifying a username and password for the publisher.

In the example shown in FIG. 11, the page 1100 includes a plurality of input fields that allow the publisher to input information regarding a collection of cards the publisher intends to publish. For instance, a collection name text input field 1102 allows the publisher to provide a name for a collection of cards. A description text input field 1104 allows the publisher to provide a description of the collection, which may be a short paragraph describing content of the collection. Information provided by the publisher into the collection name text input field 1102 and description text input field 1104 (and/or other fields) may, upon publishing of the collection, be indexed in order to facilitate searches and analysis of cards. A templates input field 1106 allows a publisher to upload one or more templates for the publisher's cards of the collection. A template, in an embodiment, is an electronic document, such as an (extensible markup language) XML document, that provides one or more specifications for a card. The specifications may be used, at least in part, to determine how content associated with cards are displayed on user devices. For instance, the specifications of a template may define content and layout of the content for one or more cards created based at least in part on the template. In an embodiment, the publisher can textually input a path or other identifier of one or more locally stored documents into the template input field 1106. Alternatively, the publisher may select a browse button 1108 that, upon selection, provides the publisher the ability to navigate through a file system to locate a template file. The template input field 1106 and browse button 1108 may also be used by the publisher to specify network locations of documents, such as documents that are stored on a server.

While FIG. 11 shows an illustrative example of an interface page that allows the publisher to provide information about a collection, variations are contemplated as being within the scope of the present disclosure. For example, a fewer or greater number of input fields may be provided. As one example, the publisher on the page 1100 or another page may provide a number of blanks and may allocate a number of blanks to a template. In an embodiment, a blank is a pattern for a group of cards associated with the same content. As a concrete example, if the publisher intends to publish a set of baseball cards, a blank may be a pattern for a set of cards associated with the same picture of a particular baseball player. Upon providing input in the various fields of the page 1100, the publisher in an embodiment, may select a next button 1110 to navigate to another page of the interface. In an embodiment, selection of the next button 1110 directs information provided by the publisher to be sent to a computer system that facilitates publishing of cards, although information may be sent at other times, such by utilizing asynchronous JavaScript and XML (AJAX) techniques to send information dynamically.

FIG. 12 shows an illustrative example of an interface page 1200 that may be provided to a publisher upon selection of the next button 1110, described above or that may be provided to the publisher subsequent to other navigation. In the illustrative example of FIG. 12, a plurality of blanks are displayed to the publisher and the publisher is allowed to provide information for each blank. In the example of FIG. 12, a first blank 1202 and a second blank 1204 are displayed. A scroll bar 1206 allows the publisher to navigate to other blanks not currently displayed in the interface page. In an embodiment, the publisher selects one or more blanks and provides attributes for the selected blank(s). The attributes may include, but are not limited to, a template assigned to the blank, content for the blank, a number of cards to be published for each blank, a title for the blank, keywords and other meta data for the blank, and the like. As shown by a box surrounding the first blank 1202, the publisher has selected the first blank 1202. Thus, information provided by the publisher while the first blank 1202 is selected will be sent and stored for the first blank 1202. In addition, in an embodiment, if the publisher had selected multiple cards, input may be provided for multiple blanks at once. For instance, a publisher may select all blanks with which the publisher intends to use a single template and assign the template to the selected blanks at once. The publisher may then select individually blanks to provide information for the individual blanks that does not apply to every blank assigned the same template. As another concrete example, the publisher may select one or more blanks and utilize a mint size input field 1208 to assign a number of cards to be published form the selected blank(s). As shown, the mint size input field 1208 is a drop down box that additionally allows numerical input, but other interface elements may be used. Thus, with the first blank 1202 selected, the mint size input field 1208 may be used to allow the publisher to specify how many cards are to be published for the first blank 1202. In this manner, the publisher is provided the ability to control the rarity of the cards it publishes.

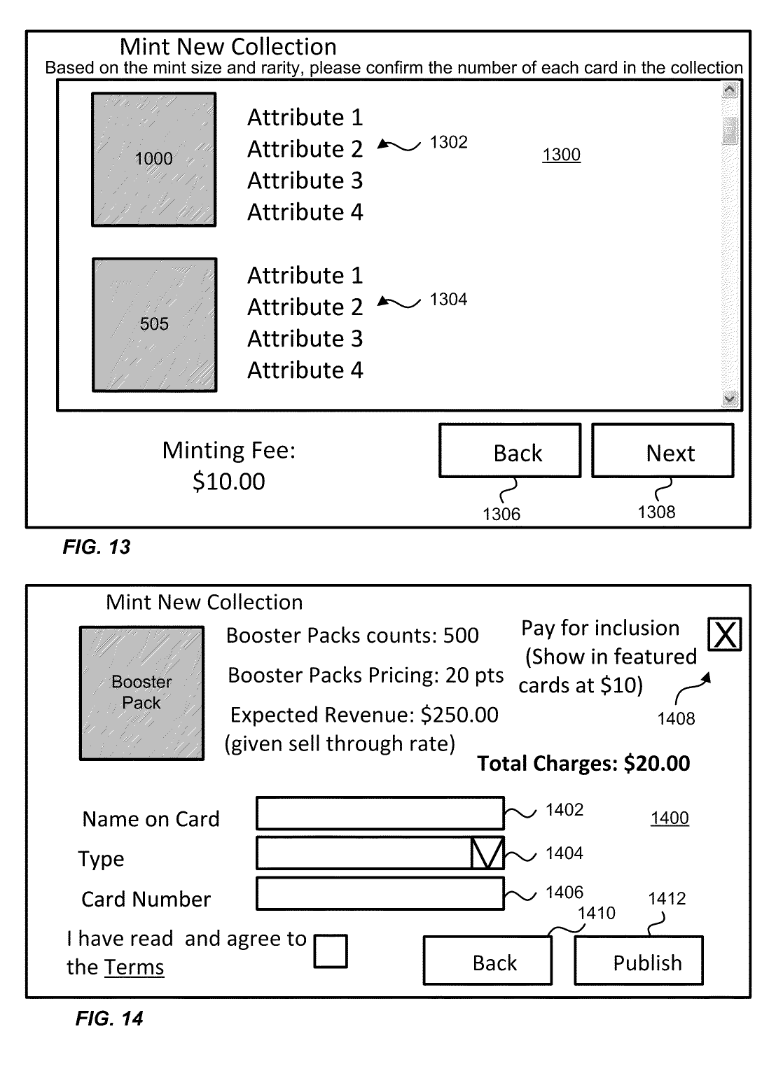

In an embodiment, the interface page 1200 includes a back button 1210 that allows the publisher to navigate to a previous interface page in order to make changes and a next button 1212 that allows the publisher to submit information and navigate to a next interface page. For instance, FIG. 13 shows an illustrative example of an interface page 1300 to which the publisher may navigate from the interface page 1200 shown in FIG. 12. In this example, the interface page 1300 shown in FIG. 13 provides the publisher information regarding the information the publisher has provided for publishing its cards, thereby, allowing the publisher to confirm that the information is correct. In this example, the blanks and the attributes input for the blanks are displayed to the publisher. Additionally, in an embodiment, a number representative of the number of cards to be published for each blank is superimposed or otherwise displayed in order to provide the publisher immediate access to supply information for the cards. In addition, in an embodiment, a minting fee to be charged to the publisher is displayed to provide the publisher a cost for publishing the cards. The mint fee may be based at least in part on the number of cards to be published. It should be noted that alternate revenue models may also be used in addition to or as an alternative to a minting fee. Examples include commissions on card sales, revenue generated on a cost-per-click or cost-per-impression basis, and other revenue models.

As above, the interface page 1300 may include a back button 1306 and a next button 1308 that enables the publisher to navigate backwards or forwards, respectively, to other interface pages and, if applicable, submit information that has been input.

Accordingly, FIG. 14 shows an illustrative example of an interface page 1400 that allows the publisher to confirm an order to publish the collection. The interface page 1400 may appear to the publisher subsequent to selection of the next button 1308 shown in FIG. 13, although intermediate pages for collecting input from the publisher may have been displayed prior to display of the interface page 1400 shown in FIG. 14. As shown, information regarding the collection is provided for review by the publisher. In this example, the publisher has arranged for the cards of the collection to be distributed in booster packs, where 500 booster packs are to be distributed in total, where a booster pack (or, simply, “pack”) may be as described above. In an embodiment, cards are automatically arranged into booster packs in a random or semi-random distribution and each booster pack has a standard number of cards. However, in an embodiment, publishers may vary how cards are distributed and/or how many cards are in a booster pack. For instance, publishers may have various levels of control of what cards are in each booster pack. In some instances, publishers can specify the content of each booster pack, specify conditions for distribution of cards among the booster packs, and/or specify other options. In addition, publishers, in an embodiment, can publish starter packs, where a starter pack is a set of cards having more cards than a booster pack. A starter pack, for instance, may include enough cards to enable a user to purchase a starter pack and engage in a card-related game.

As shown in FIG. 14, the interface page 1400 includes a plurality of fields. In the example shown, a plurality of fields related to credit card payments are included. For instance, a name text input field 1402 allows the publisher to input the name on a credit card to be used for payment. A type drop down menu 1404 allows the publisher to input the type (Visa, MasterCard, American Express, e.g.) of credit card being used to pay for publishing and a card number numerical input field 1406 allows the publisher to input a credit card number of the credit card being used. While the example shown in FIG. 14 provides for payment by credit card, other modes of payment may also be provided to publishers. For instance, publishers may establish account and may receive bills, publishers may pay by alternative payment systems, and, generally, publishers may be provided the ability to pay using any suitable form of payment.

In addition, in addition to the foregoing, publishers may be able to pay for promotion in connection with the cards the publisher is publishing. As an example, the interface page 1400 includes a promotion checkbox 1408 that allows the publisher to pay an additional fee for promotion of the cards being published. In the example shown, the publisher can use the promotion checkbox 1408 to cause the published cards to be featured in one or more electronic marketplaces for cards. For instance, the published cards may be featured prominently to users visiting an electronic marketplace.

As with interface pages discussed above, the interface page 1400 also includes a plurality of navigational buttons, such as a back button 1412 that may be utilized in a manner similar to that described above. Also, in an embodiment, the interface page 1400 also includes a publish button 1412 that allows a publisher to publish the collection according to any criteria that the publisher has specified using the interface. Publishing a collection of cards, in an embodiment, includes making the cards of the collection available to other entities, such as consumers. Publishing cards may include making cards available for transaction in one or more electronic marketplaces and/or on one or more social networks. Publishing may also include other ways of distributing cards, such as by providing cards (or packs of cards) to members of a fan club that have requested cards. In one embodiment, publishers can tie the number of cards (or packs) distributed to a number of people who sign up for distribution. In this manner, people expecting cards are not disappointed while rarity may be controlled by not distributing more cards than necessary.

While FIGS. 11 through 14 provide examples of interface pages that may be used in accordance with various embodiments, variations are contemplated as being within the sprit of the present disclosure. For instance, while the interface pages described above provide publishers the ability to provide various criteria for publishing a collection of cards, variations of the above-described pages are contemplated, including additional pages and pages that allow publishers to specify various other criteria for publishing cards. For instance, publishers may be provided with the ability to time releases of collections, such as to coincide with release of television shows, movies, and other events. Publishers may also be provided with the ability to stagger distribution of cards and otherwise specify how distribution is to be made.

Although specific embodiments of the invention have been described, various modifications, alterations, alternative constructions, and equivalents are also encompassed within the scope of the invention. Embodiments of the present invention are not restricted to operation within certain specific data processing environments, but are free to operate within a plurality of data processing environments. Additionally, although embodiments of the present invention have been described using a particular series of transactions and steps, it should be apparent to those skilled in the art that the scope of the present invention is not limited to the described series of transactions and steps.

Further, while embodiments of the present invention have been described using a particular combination of hardware and software, it should be recognized that other combinations of hardware and software are also within the scope of the present invention. Embodiments of the present invention may be implemented only in hardware, or only in software, or using combinations thereof.

The specification and drawings are, accordingly, to be regarded in an illustrative rather than a restrictive sense. It will, however, be evident that additions, subtractions, deletions, and other modifications and changes may be made thereunto without departing from the broader spirit and scope of the invention.

Other variations are within the spirit of the present invention. Thus, while the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A computer-implemented method of provisioning content, comprising:
under the control of one or more computer systems configured with executable instructions,
receiving specifications for a finite set of electronic items from a publisher, the set of electronic items having a cardinality;
arranging a data set to represent the set of electronic items according to the received specifications;
for each electronic item of at least a plurality of the electronic items, updating the data set to associate the electronic item with a corresponding owner of the electronic item; and
maintaining the data set according to ownership-affecting transactions between owners of electronic items from the set of electronic items such that the cardinality of the set of electronic items is non-increasing.

2. The computer-implemented method of claim 1, wherein the electronic items are electronic trading cards.

3. The computer-implemented method of claim 1, wherein the transactions include trades, purchases, or gifts of the electronic items.

4. The computer-implemented method of claim 1, wherein the electronic items include content and wherein the method further comprises providing representations of at least some of the electronic items to users over a public communications network.

5. The computer-implemented method of claim 1, further comprising operating a marketplace in which the ownership-affecting transactions are completed.

6. The computer-implemented method of claim 1, wherein the specifications include content for each of the electronic items and a number of electronic items for the set.

7. The computer-implemented method of claim 1, wherein maintaining the data set is performed to ensure that the cardinality of the set is non-increasing.

8. The computer-implemented method of claim 1, wherein receiving the specifications is performed through an interface accessible to a plurality of different third party publishers.

9. A computer system for enabling a trading metaphor, comprising:
one or more processors; and
memory including instructions that, when executed collectively by the one or more processors, cause the computer system to at least:
publish a finite set of electronic items according to publisher specifications, the set having a cardinality;
associate each electronic item of at least a subset of the electronic items with an owner; and
provide owners of the electronic items the ability to change ownership of the electronic items while preventing increase in the cardinality of the set of electronic items.

10. The computer system of claim 9, wherein providing the owners of the electronic items the ability to change ownership includes providing an interface for changing ownership over a public communications network.

11. The computer system of claim 9, wherein publishing the finite set of electronic items includes making the electronic items available to be associated with owners.

12. The computer system of claim 9, wherein publishing the finite set of electronic items includes associating the electronic items with corresponding owners.

13. The computer system of claim 9, further comprising:
providing, over a public communications network, an interface for inputting the publisher specifications, the interface being available to a plurality of third-party publishers; and
receiving the publisher specifications via the interface.

14. The computer system of claim 13, wherein the interface provides the ability to specify content for the electronic items and the cardinality.

15. The computer system of claim 9, wherein the instructions further cause the computer system to at least:
enable a person to complete a signing action for at least one of the electronic items owned by an owner different from the person;
maintain data that indicates that the at least one of the electronic items is signed by the person; and
provide one or more representations of the item that indicate that the at least one of the electronic items is signed by the person.

16. One or more computer-readable storage media having collectively stored thereon instructions that, when executed collectively by one or more processors of one or more computer systems, enable one or more computer systems to at least:
receive specifications for a finite set of electronic items from a publisher, the set of electronic items having a cardinality;
arrange a data set to represent the set of electronic items according to the received specifications;
for each electronic item of at least a plurality of the electronic items, update the data set to associate the electronic item with a corresponding owner of the electronic item; and
maintain the data set according to ownership-affecting transactions between owners of electronic items from the set of electronic items such that the cardinality of the set of electronic items is non-increasing.

17. The one or more computer-readable storage media of claim 16, wherein maintaining the data set includes centrally managing associations between the electronic items and corresponding owners of the electronic items.

18. The one or more computer-readable storage media of claim 16, wherein the instructions enable the one or more computer systems to additionally make content available through an interface of a social network.

19. The one or more computer-readable storage media of claim 18, wherein the instructions enable the one or more computer systems to further facilitate the ownership-affecting transactions through the interface of the social network.

20. The one or more computer-readable storage media of claim 16, wherein the instructions enable the one or more computer systems to limit the number of concurrent owners of the electronic items to the number of electronic items.
